(19) United States
(12) Patent Application Publication
(10) Pub. No.: US 2023/0026931 A1
(43) Pub. Date: Jan. 26, 2023

(54) PROCESS FOR CLEANUP AND RECYCLING OF ROLLING OILS

(71) Applicant: MEDIA AND PROCESS TECHNOLOGY INC., Pittsburgh, PA (US)

(72) Inventors: Paul KT LIU, Lafayette Hill, PA (US); Richard J. CIORA, Butler, PA (US); Douglas PARSLEY, New Kensington, PA (US)

(21) Appl. No.: 17/870,250

(22) Filed: Jul. 21, 2022

Related U.S. Application Data
(60) Provisional application No. 63/224,262, filed on Jul. 21, 2021.

(51) Int. Cl. B01D 17/02; B01D 17/04; B01D 17/00; C02F 9/00; B01D 21/26; C10M 175/00

(52) U.S. Cl. CPC B01D 17/0217; B01D 17/042; B01D 17/085; C02F 9/00; B01D 21/262; C10M 175/0058; C02F 1/385

(57) ABSTRACT

A method for cleanup of circulated rolling oil including gravity separation followed by size separation. The method includes supplying the circulated roiling oil to a separation chamber of a rotating centrifugal rotor and separating water and solid debris from the circulated rolling oil by centrifugal force. Oil, oil-water emulsion, and some residual debris may be recovered and supplied to a ceramic membrane having a pore size of 1.5 micron or smaller. A purified oil sample is recovered from the membrane, along with a reject including the oil-water emulsion and residual debris. The reject may be further concentrated by gravity separation and recycled to the membrane to recover further amounts of oil.

### CROSS-REFERENCE To RELATED APPLICATIONS

The present application claims the benefit under 35 U.S.C. § 119(e) of prior U.S. Provisional Application Ser. No. 63/224,262, filed Jul. 21, 2021, the content of which is incorporated by reference hereinto this application.

### TECHNICAL FIELD

The present disclosure is directed to a process for the recycling of spent oil/water mixtures. More specifically, it is a process for the rejuvenation or regeneration of spent oil/water mixtures used in the metal processing industry.

### BACKGROUND

In the processing of flat-rolled metal products such as sheet or plate, rolling oil is used as a lubricant to improve rolling efficiency and act as a coolant. Moreover, the rolling oil can prevent metal sticking and other process-related problems encounter in rolling, e.g., pickup, and thus improves product quality. In general, rolling oils include water for the purpose of cooling, surfactants and oils such as fatty acids to take advantage of their ability to form emulsions with the water, and additives to improve the corrosion resistance and oxidation stability of the oil/water mixture. During the rolling process, the additives may degrade with exposure to heat and other contaminants, and metal debris is expected to contaminate the rolling oil, which will affect the quality of the rolled product. Thus, rolling oil is often used through a single cycle, or only several cycles, and becomes spent and is conventionally discarded. Since the oil viscosity is high, and the contaminants can include extremely fine debris, cleanup of this type of spent oil for reuse has been considered a great technical challenge.

Presently, rolling oil can be used as once-through or recycle/reuse in-situ for several cycles. For the former mode, the rolling oil becomes waste after a single rolling cycle that requires disposal. For the latter, the oil must be cleaned with a screen or other in-line filtration device to remove debris before recycling for reuse. Even after filtering, however, the rolling oil becomes spent after several cycles and requires disposal. Nationwide, multiple millions of gallons of rolling oil are spent annually; this not only wastes tremendous natural resources, but also causes serious environmental issues.

Prior art processes for recycling rolling oils generally include steps directed to removal of particulates only, such as filtration, centrifugation, and magnetic separation. For example, CN 213375477U discloses a system designed to filter out debris generated from metal rolling applications. The system includes a basket filter to remove bulk debris, and a second finer filter in a container with a plunger for pushing the oil through this filter to further remove finer debris. Finally, the filtered oil is collected in a storage container for delivering to the rolling device. The oil in the storage container can be recirculated back to the basket filter for continuous cleaning via circulation. While this process may be effective for removal of particulate debris, it does not provide separation of degraded additives and/or micro oil/water emulsions.

CN 2034719760 discloses a system for regeneration of machining coolants used for metal cutting lubrication and cooling. The system includes a feed tank, wherein details about the feed tank design include its liquid level control, electronic control of the system operation, transfer of the regenerated coolant for reuse, and return of the used coolant for regeneration. Though cleanup with centrifuge and membrane are mentioned, there are no details about their operation, or specifications of the membranes and their cleanup efficiency. Instead, the use of a centrifuge, membrane, or centrifuge in conjunction with membrane is mentioned only as possible means to remove cutting debris. Thus, as with CN 213375477U, no separation of oil from oil/water emulsion is discussed.

Similarly, CN114395414A discloses a membrane-based process for cleaning up the spent neat rolling oil. The dirty oil is fed through a pre-filter with a pore size of 50 to 100 μm and then a polymeric hollow fiber membrane with the pore size of 0.01 to 0.2 μm. CN104841276 discloses a system that is limited to the cleanup of used neat rolling oil, i.e., oils absent water and oils-water emulsions. The system includes polymeric membranes as a first step for removal of solid debris, followed by centrifugation of the membrane reject, which includes solid contaminated with solid debris. Neither system nor method include steps that address removal of oil-water emulsions.

Other prior art methods have tried to address the issue of water removal from rolling oils. For example, JP2005000904A discloses a method for removal of solid debris and water from circulating lubricants or rolling oil using crude pretreatment to remove solid debris and water followed by filtration on a hydrophobic porous hollow fiber membrane, such as a polyolefin membrane. The polymeric membranes disclosed in JP2005000904A, however, are not stable at elevated temperatures.

Accordingly, simplified, durable, cost effective processes for cleanup and recycling of rolling oils are desired.

### SUMMARY

The present disclosure provides a simplified process for the cleanup of circulated rolling oils comprising two durable steps, gravity separation and size separation, without the need for added chemicals. These two steps may be executed by a system that effectively and economically produces recycled rolling oils of excellent purity.

Accordingly, the present disclosure relates to a method for cleanup of circulated rolling oils that include solid debris, free water, oil, and oil-water emulsions. The method comprises separation of the components of the circulated rolling oil by density, such as by gravity separation or by supplying the circulated rolling oil to a separation chamber of a rotating centrifugal rotor and separating the components of the circulated rolling oil by centrifugal force. A supernatant comprising the oil, a substantial portion of the oil-water emulsion, and a residual debris may be recovered and supplied to an inorganic membrane, wherein the oil is recovered from the membrane and a reject comprising the oil-water emulsion and residual debris does not permeate the membrane. The reject may be further concentrated by gravity separation and recycled to the membrane to recover further amounts of oil.

The present disclosure also relates to a method for in-line cleanup of circulating rolling oils. The method generally includes supplying a portion of a circulating rolling oil from a metal rolling process, such as 5 to 15% (v/v), to the density and size separating steps indicated hereinabove, and supplying the purified oil recovered therefrom back to the circulating rolling oil. The purified oil may be supplemented with additives before supplying, back to the circulating rolling oil of the rolling process.

According to aspects of the methods, the circulated or circulating rolling oil may be heated prior to centrifugation and/or membrane purification, such as to a temperature of 50° C. or greater. Moreover. the membrane may be a ceramic membrane having a pore size of 1.5 micron or smaller, such as less than 1.5 micron, or 1.0 micron or smaller, or 0.5 micron or smaller, or 0.2 micron or smaller, or 0.1 micron or smaller, or 0.05 micron or smaller. Further yet, the centrifugal force may be between 500 G and 14,200 G.

The present disclosure also relates to systems useful to execute the methods described herein, and recycled rolling oils produced by these methods and systems.

### BRIEF DESCRIPTION OF THE DRAWINGS

FIG. 1 illustrates a system for cleanup of circulated rolling oil according to aspects of the present disclosure.

FIGS. 2A and 2B illustrate representative separation of components of a circulated rolling oil into layers after a density separation step according to aspects of the present disclosure.

FIGS. 3-5 provide graphs showing volume of oil, water, and oil-water emulsion, respectively, of a circulated rolling oil separated after a density separation step according to aspects of the present disclosure.

### DETAILED DESCRIPTION

In general, rolling oil contains petroleum oil, and/or animal/plant sources of fatty acid and additives, such as anti-corrosion agents and others. These valuable resources can be reused if the impurities picked up from the rolling process can be removed. In addition, the additives consumed or degraded can be re-additized. Thus, the present disclosure provides an efficient cleanup process and system to rejuvenate used rolling oils sufficient for reuse. In the process, gravity separation such as centrifugation, provides recovery of at least the oil and an oil-water emulsion from the circulated rolling oil, followed by membrane filtration of the recovered components to supply a cleaned rolling oil.

Throughout this description and in the appended claims, use of the singular includes the plural and plural encompasses singular, unless specifically stated otherwise. For example, although reference is made herein to “an” emulsion, “a” solid debris, and “the” oil, one or more of any of these elements and/or any other components described herein can be used.

The word “comprising” and forms of the word “comprising”, as used in this description and in the claims, does not limit the present invention to exclude any variants or additions. Additionally, although the present invention has been described in terms of “comprising”, the methods detailed herein may also be described as consisting essentially of or consisting of For example, while the invention has been described in terms of a method comprising a centrifugation step and a size separation step, a method consisting essentially of a centrifugation step and a size separation step is also within the present scope. In this context, “consisting essentially of” means that any additional method steps will not materially affect the efficiency of the method, i.e., recovery of recycled oil. As an additional example, a method comprising a heating step, centrifugation step, a size separation step, and a recycling step may also be understood to include a method consisting essentially of these same steps.

Various aspects of the processes and systems disclosed herein may be illustrated by describing components that are coupled, attached, and/or joined together. As used herein, the terms “coupled”, “attached”, and/or “joined” are interchangeably used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements shown in said examples.

Various aspects of the processes and systems disclosed herein may be illustrated with reference to one or more exemplary implementations. As used herein, the term “exemplary” means “serving as an example, instance, or illustration,” and should not necessarily be construed as preferred or advantageous over other variations of the systems or methods disclosed herein. “Optional” or “optionally” means that the subsequently described event or circumstance may or may not occur, and that the description includes instances where the event occurs and instances where it does not.

Furthermore, the use of “or” means “and/or” unless specifically stated otherwise. “Including” and like terms means including, but not limited to. When ranges are given, any endpoints of those ranges and/or numbers within those ranges can be combined within the scope of the present invention.

“Substantially”, as used herein, is understood to mean that a value or measurement is within 10% of a listed value, such as within 5%, or even 3% of a listed value. Thus, a component that is substantially free of a contaminant or additional component has no more than 10% (either wt. % or v/v), or 5%, or 3%, or 2%, or 1% of the contaminant or additional component. A component that is totally free of a contaminant or additional component should be understood to mean that the component has little to no measurable contaminant or additional component (e.g., measurable as PPM).

Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and appended claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

The presently disclosed two-step process is much simpler than currently known processes. No pre-treatment before the first centrifugation step is required, and no chemicals are added to facilitate agglomeration of debris and/or removal of emulsified water in oil. Moreover, the durable ceramic, hydrophilic membranes of the second step provide a substantially water and debris free oil sufficient for reuse.

While described as useful for the cleanup and recycling of rolling oils, other industrial process oils may be cleaned up and recycled using the processes and systems disclosed herein.

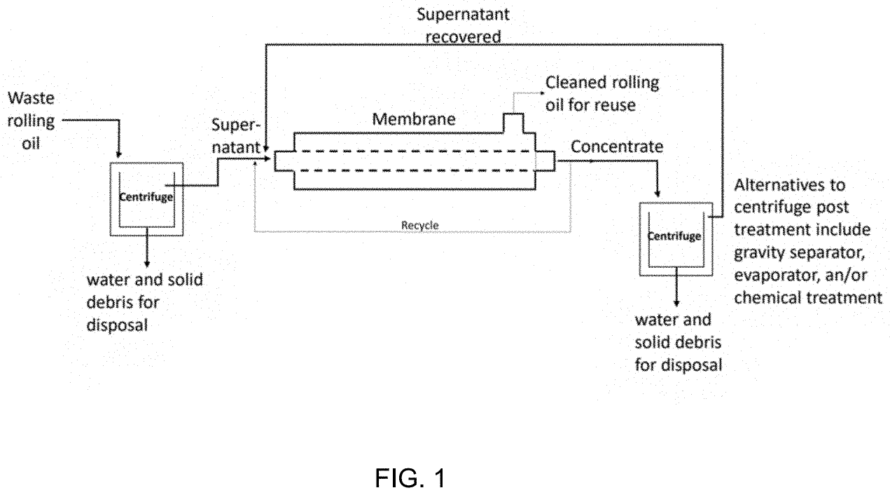

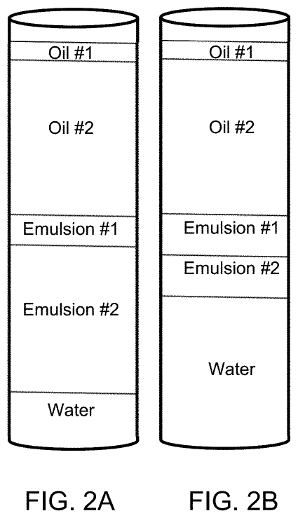

With reference to FIG. 1, the processes for cleanup of circulated rolling oil of the present disclosure includes two steps. A first step in the process comprises gravity separation. This step separates the various components of the circulated rolling oil by density. According to certain aspects, the gravity separation may be accomplished in a static tank over a period of hours to days and may provide separation of the oil from water, water-oil emulsion, and solid debris. According to certain other aspects, the separation may be accomplished by centrifugal force using a centrifuge, which separates the components of the circulated rolling oil into layers such as a solid debris layer, a water layer, oil-water emulsion layers (commonly known as rag layers, which may contain residual debris), and oil layers (see FIG. 2A and 2B).

The circulated or waste rolling oil may be heated prior to centrifugation, such as to temperatures of at least 50° C. In exemplary processes, the circulated rolling oil may be heated to at least 60° C., or at least 70° C., or at least 80° C., or at least 90° C., such as 50° C. to 90° C., or 60° C. to 80° C., etc., prior to centrifugation. This heating step may facilitate breakdown of the oil-water emulsions, allowing a more efficient recovery of the oil in the gravity separation methods. While higher temperatures may provide a more efficient oil recovery, a practical temperature range that reduces energy use but still provides excellent recovery of oil in the first step was found to be about 60° C. or greater, such as 60° C. to 90° C.

The supernatant from this first step comprising the oil may be provided to an inorganic membrane for a size separation step. In general, each of the oil and a portion of the oil-water emulsion layers may be supplied to the membrane. The membrane is configured to allow the rolling oil to permeate while retaining the emulsified water and any residual debris. The concentrated retentate from the membrane process, i.e., referred to herein as the reject, can be further treated with heat to break the oil-water emulsion contained therein. Finally, the debris and water from this reject material can be settled naturally or separated with a centrifuge before returning the oil thus separated back to the membrane process.

According to certain aspects, these steps may be in the manner of a recirculation, such that the heated reject material may be supplied to the centrifuge of the first step and the process continued as described. Alternatively, the reject may be supplied to a second centrifuge, and the supernatant from this second centrifugation may be supplied to the membrane of step two, or to a different inorganic membrane having the same or similar characteristics (i.e., size separation membrane).

According to certain aspects, the rolling oil cleaned using the methods disclosed herein may be supplied as a waste oil from a metal rolling process, i.e., a rolling oil that has been circulated one or more times through the metal rolling process.

Alternatively, the methods disclosed herein may be performed “in-line” with a metal rolling process. That is, a portion of the rolling oil circulating in a metal rolling process may be removed and supplied to the density and size separation steps disclosed herein. For example, 5% (v/v), 10% (v/v), 15% (v/v), 20% (v/v), or even 25% (v/v) of the rolling oil circulating in a metal rolling process may be removed for cleanup using the presently disclosed methods. The purified oil recovered from the methods, i.e., from the size separation step (i.e., the inorganic membrane), may be recycled back to the circulating rolling oil. Before recycling the purified rolling oil back into the metal rolling process, various additives may be supplemented. Such a method may extend the overall lifespan of the circulating rolling oil and provide a metal rolling process having fewer interruptions.

The amount of circulating rolling oil removed in such an in-line process may depend on the volume of the rolling process, characteristics of the cleanup method (e.g., amount of heating provided to the density and size separation steps; the size and volume limits for the density and size separation steps; etc.) and the acceptable level of contaminants in the rolling oil (e.g., solid debris, etc.).

The present inventors have found that centrifugation at a centrifugal force of 500 G (about 2,000 RPM on a 13 cm rotor) to about 14,200 G (about 10,000 RPM on a 13 cm rotor) is sufficient to provide separation of the various components of the circulated rolling oil, i.e., oil layers, oil-water emulsion layers, water, and solid debris. According to certain aspects, the centrifugal force may be at least 500G, such as at least 1,000 G, or at least 2,000 G or at least 3,500 G, or at least 5,000 G, or at least 10,000 G. According to certain aspects, the centrifugal force may be 14,200 G or less, or 10.000 G or less, or 5,000 G or less. The centrifugal force may be any combination of lower and upper values disclosed herein, such as 500 G to 5,000 G, or 3,500 G to 10,000 G, and the like.

The present inventors have also found that use of a ceramic membrane provides improved purification of the circulated rolling oil and streamlines the process. That is, ceramic membranes have a rugged structure, which can sustain harsh operation at a high temperature. Use of higher temperature operation may be advantageous for oil permeation of the membrane since the viscosity of the oil decreases along with the temperature increase thus, the permeation rate increases. As example, heating the membrane to ≥120° C. may improve the production rate of the membrane. The polymeric hollow fiber membranes used in the prior art are not stable at this operation range.

Moreover, the permeate oil obtained from use of such ceramic membranes is free of turbidity, indicating that no water emulsion penetrates through the ceramic membrane having the hydrophilic surface. This is somewhat unexpected, as the prior art suggests that a hydrophobic membrane is needed to provide separation of the oil from the roiling oil.

Thus, according to preferred aspects, the membranes of the processes disclosed herein may be ceramic membranes, or surface treated ceramic membranes. The membranes may be designed as tubular, honeycomb, sheet, and the like. The membranes may have a pore size of 1.5 micron or smaller, such as less than 1.5 micron, or 1.0 micron or less, or 0.5 microns or less, or 0.2 micron or less, or 0.1 micron or less, or even 0.05 micron or less.

The supernatant from the centrifugation step may be heated prior to supplying to the membrane and/or the membrane may be heated during operation. In exemplary processes, the supernatant and/or membrane may be heated to at least 60° C., or at least 70° C., or at least 80° C., or at least 90° C., or at least 100° C., or at least 110° C., or even 120° C. or greater. As indicated before, this heating step may facilitate breakdown of the oil-water emulsions, allowing a greater recovery of the oil from the membrane.

This unique combination of a first step comprising centrifugation at 500 G to 5,000 G followed by a membrane permeation step on a ceramic membrane haying a hydrophilic surface and a pore size of 1.0 micron or less, such as or 0.1 micron or less, or even 0.05 micron or less, provides a purified rolling oil absent turbidity, i.e., having less than 5 wt. % water and/or water-oil emulsion, such as less than 2 wt. %, or less than 1 wt. %, or substantially free of water and/or water-oil emulsion, or totally free of water and/or water-oil emulsion.

Moreover, the unique combination of a first step comprising centrifugation at 500 G to 5,000 G followed by a membrane permeation step on a ceramic membrane having a hydrophilic surface and a pore size a 0.1 micron or less, or even 0.05 micron or less, provides a. purified rolling oil absent turbidity, i.e., having less than 1 wt. % water, such as less than 0.5 wt. %, or less than 0.2 wt. %, or substantially free of water.

As indicated above, the reject material from the membrane permeation step, i.e., step two, may be supplied to a further separation means selected from a centrifuge, a gravity separator, an evaporator, and/or chemical treatment. As example, the reject material may be recycled through the first and/or second steps if the disclosed process to improve the yield,

These and other features of the systems and methods of the present disclosure will become more apparent upon consideration of the following examples. Whereas particular examples of this invention are described below for purposes of illustration, it will be evident to those skilled in the art that numerous variations of the details of the present invention may be made without departing from the invention as defined in the appended claims. All parts and percentages in the examples, as well as throughout this specification, are by weight unless otherwise indicated.

### EXAMPLES

All parts and percentages in the examples, as well as throughout the specification, are by weight unless otherwise indicated.

### Example 1: Oil/Water Separations with Centrifugation

The first step for cleanup and recycling of spent rolling oil according to the present disclosure is separation of a substantial amount of the water and solid debris from the spent oil and oil/water emulsion. The recovered oil and oil/water emulsion can then be further processed while the separated water can be sent to a wastewater treatment facility. Since the objective of the methods of the present disclosure is recycling and reuse of the rolling oil, it is beneficial to concentrate the oil as much as possible before further cleanup. Theoretically, oil with a sufficiently high quality can be recovered if a sufficient G force is applied to separate water and solid debris from the rolling oil. However, the emulsion state of the oil/water mixture formed by surfactants provided by fatty acid and other chemical additives is often very stable; physical separations via standard centrifugation is inadequate even with a high G force, such as 14,200 G, which is considered as an upper end for an industrial centrifuge. Thus, for some waste oil and wastewater treatment processes, demulsifying chemicals are used along with the centrifugation to break these emulsions. Unfortunately, for the purpose of recycle and reuse of industrial process fluids, such as rolling oil, chemical demulsification is not optimal due to its potential to modify the rolling oil properties or negatively damage the surface of the metal object under rolling. Thus, the quality of the oil recovered with a centrifugation step alone is usually not good enough for recycle and reuse.

Impact of G-Force on Rolling Oil Recovery

Centrifugation of spent rolling oils at different centrifugal forces was investigated to find an optimal centrifugal force, or G-force, for use as a first step in the process. A typical profile of separated layers of a spent rolling oil after centrifugation at 2,000 RPM, equivalent to 570 G, and at 5,000 RPM, equivalent to about 3,600 G, are presented in FIGS. 2A and 2B, respectively. Water is shown to separate as the bottom layer due to its high density. Depending on the additives used in the rolling oils and/or the discharge limits of the treatment facility, the bulk water removed in a first separation stage (i.e., gravity, centrifugation, etc.) may be sent directly to a water treatment facility.

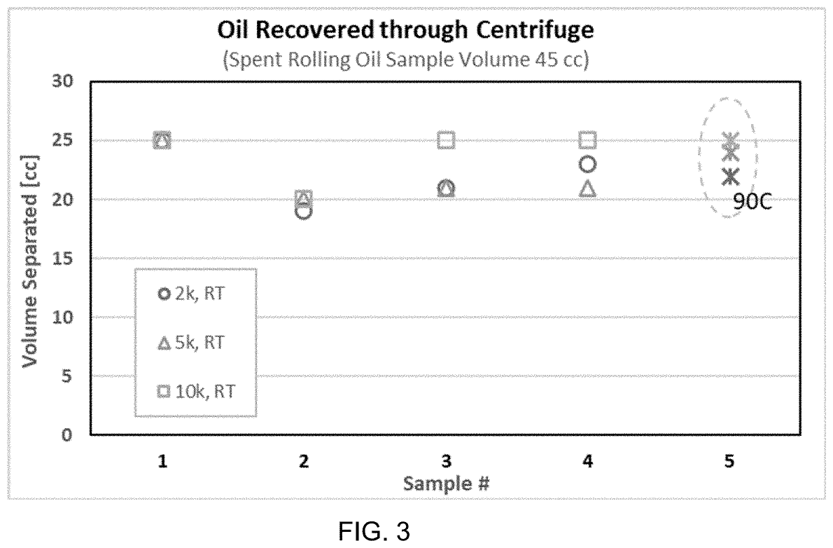

Shown in FIG. 3 are data for centrifugation of spent rolling oils at 2,000 to 10,000 RPM (equivalent to 570 G to 14,199 G). Surprisingly the volume of oil recovered from centrifugation at 2,000 to 10,000 RPM remains similar, although the quality of the oil from higher RPM centrifugation appears better in terms of its degree of turbidity. Turbidity indicates contamination of the oil with water and other additives or debris. Thus, after centrifugation at lower speeds, i.e., 2000 RPM, the higher degree of turbidity is an indication that the oil contains a larger amount of water, such as oil-water emulsion. With continued reference to FIGS. 2A and 2B, oil #1 is the cleanest oil layer, i.e., has little turbidity, and oil #2 is a very turbid oil layer. The degree of turbidity of the oil #1 and #2 layers is reduced at higher speed centrifugation but is not eliminated. Throughout the description of the methods in this disclosure, the oil #1 and oil #2 layers together comprise the oil.

On the other hand, the separation of water and the formation of rag layers improves significantly with higher speed centrifugation. Rag layers are mixtures of dispersed oil, water, and fine solids or residual debris, and are referred to herein as emulsion layers #1 and #2. Emulsion #1 is an emulsion layer comprising a majority of oil while emulsion #2 is an emulsion layer comprising a majority of water. For example, as shown in FIGS. 2A and 2B, the relative positions of the water and emulsion layers change with an increased centrifugation speed, i.e., 2,000 RPM to 5,000 RPM, respectively. Throughout the description of the methods in this disclosure, emulsion #1 and #2 together comprise the oil-water emulsion.

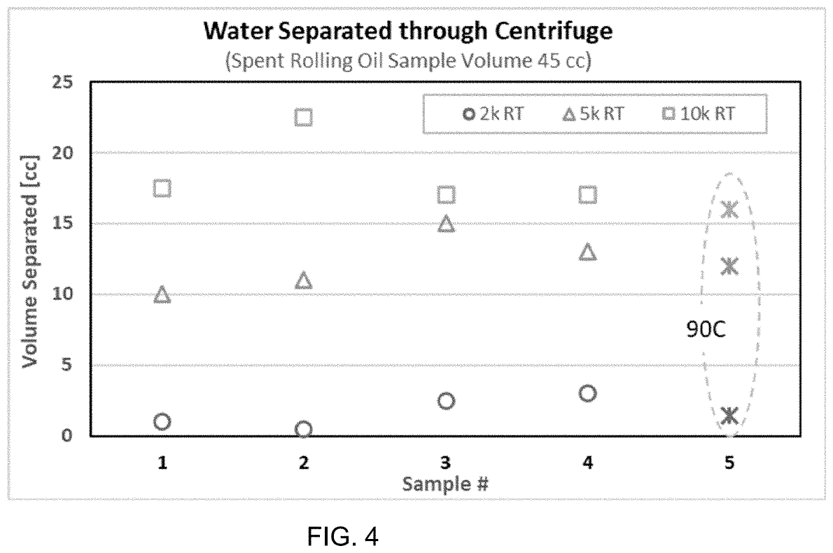

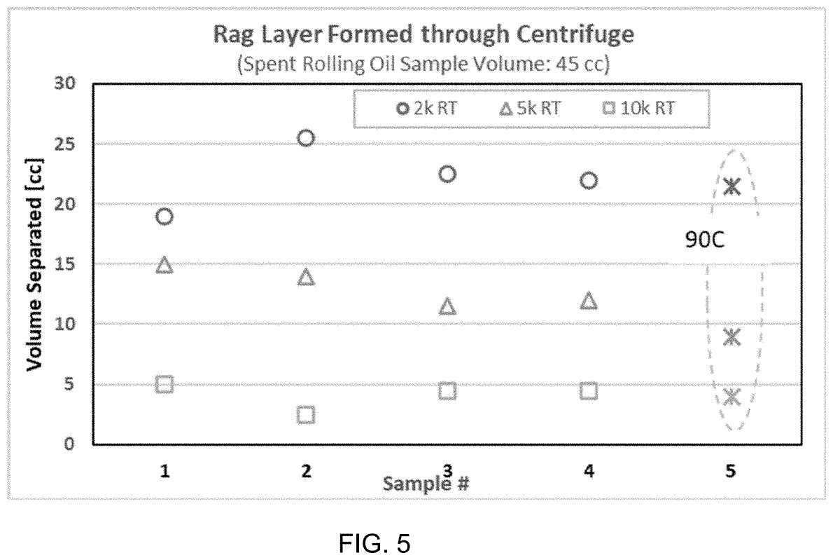

The improved separation of the oil-water emulsion with increased centrifugal speed is shown in FIG. 5 (emulsion layers are commonly referred to as rag layers). The emulsion layers diminish dramatically, from 20-25 ml to ≤5 ml for a 45 ml (i.e., ‘cc’) sample with an increased centrifugation speed from 2,000 to 10,000 RPM. Similarly, as shown in FIG. 4, the water recovered increases from 0 to ˜2.5 ml to about 20±2 ml for a 45 ml (i.e., ‘cc’) sample with an increased centrifugation speed from 2,000 to 10,000 RPM.

Circulated rolling oils may be stored prior to cleanup. As such, certain solid debris may settle out, such as to the bottom of a storage tank, and the circulated rolling oils transferred to the separation chamber of a rotating centrifugal rotor may be absent a significant amount of the heavier solid debris. Accordingly, certain of the layers shown in FIGS. 2A and 2B may be absent, i.e., heaviest solid debris at bottom layer. Other lighter weight solid debris may remain, however, such as mixed in the oil or emulsion layers. This is because the viscosity of the rolling oils may act to retain the fine debris therein. Heating the circulated rolling oil before centrifugation has been found to lower the viscosity of the oil and oil-water emulsions such that additional amounts of solid debris may be recovered in a bottom layer, i.e., less solid debris remains in the oil and oil-water emulsion layers. Reference to residual debris in the methods of this disclosure generally includes the smaller, lighter weight debris that may be retained in the oil and oil-water emulsion layers.

As shown in FIGS. 3-5 heating the circulated rolling oil prior to centrifugation does little to improve recovery of the oil or change the separation or distribution of the various layers. Sample 5 in each of FIGS. 3-5 was heated to 90° C. prior to centrifugation, wherein 90° C. is a practical upper limit for heating without generating significant evaporation of the water.

### Example 2: Oil/Water Separations with Membrane Filtration

As mention above, even high-speed centrifugation does not eliminate the turbidity of the oil separated from a circulated rolling oil, which stems from trapped oil-water emulsion and residual debris. In particular, the high viscosity of oil limits the effectiveness of separation based upon density for such fine contaminants. Thus, a separation process, such as membrane based upon size exclusion, as a second step would be necessary for this purpose. Particularly, an inorganic membrane is found to be an ideal choice because of its physical stability in the presence of hydrocarbons.

Impact of Membrane Pore Size on Rolling Oil Recovery

A spent rolling oil was obtained from a steel mill. The water content in the spent rolling oil from the storage tank based upon the volume analysis via a high-speed centrifuge is about 50%. This sample, after storage for several months in the lab, was subject to permeation of membranes with the nominal pore size of 1.5, 0.5, and 0.05 micron at 50° C. A clean appearance oil (i.e., relative turbid free) was obtained from the membrane with the pore size of 0.05 micron. However, no permeate was collected after 14 hours from the membrane with the pore size of 1.5 micron. The contaminants, such as oil/water emulsion, most likely plug up the pore size of 1.5 micron. However, when the pore size is small enough, such as 0.05 micron, the emulsion is rejected by the membrane while allowing the oil to flow continuously through the pore channels.

This same spent rolling oil sample from the steel mill was subjected to centrifugation at ˜14,200 G-force. The oil from the top layer was collected and supplied to a membrane with a pore size of 0.05, and a membrane with a pore size of 1.5 micron, both at 50° C. A substantially turbidity free oil was obtained from the 0.05 micron pore size membrane, while a less turbid free sample was obtained from the 1.5 micron pore sized membrane. Further, water content in the oil obtained from the 0.05 micron pore size membrane was found to be 0.110 wt. % (by the Karl Fisher method), as opposed to the water recovered from the centrifuge step, i.e., 0.962 wt. %, indicating the second step further removes nearly 90% of residual water in the oil recovered with the 14,200 G-force of the centrifugation step.

Without wishing to be bound to any one hypothesis, the present inventors believe that the oil/water emulsion after centrifugation at 14,200 G produces emulsion droplets having diameters of less than ˜1.5 micron. As such, a membrane with 1.5 micron pore size allows the emulsion having droplets <1.5 micron in diameter to flow through the membrane pore of 1.5 micron, leading to slight oil-water contamination of the filtered rolling oil sample. Accordingly, a preferred method of the present disclosure comprises a specific combination of centrifugation at centrifugal force less than 14,200 G, such as 5,000 G or less, such as 500 G to 5,000 G, and membrane filtration on a ceramic membrane having a pore size of 1.5 micron or smaller, such as less than 1.0 micron, or less than 0.5 micron, or less than 0.1 micron, or even 0.05 micron or less.

Aspects of the Disclosure

The following aspects are considered to be provided in the present disclosure:

Aspect 1: A method for cleanup of circulated rolling oil, the circulated rolling oil composed of components comprising solid debris, free water, oil, and an oil-water emulsion, wherein the method comprises gravity separation of the components to recover at least the oil and an oil-water emulsion, followed by membrane filtration of the recovered components to supply a cleaned rolling oil.

Aspect 2: The method according to aspect 1, comprising supplying the circulated rolling oil to a separation chamber of a rotating centrifugal rotor; separating the components of the circulated rolling oil in the separation chamber of the rotating centrifugal rotor by centrifugal force; recovering a supernatant comprising the oil, a portion of the oil-water emulsion, and residual debris; and supplying the supernatant to an inorganic membrane, wherein the oil is recovered from the membrane and a reject comprising the oil-water emulsion and residual debris does not permeate the membrane.

Aspect 3: The method according to aspect 1 or 2, wherein the membrane is heated to a temperature of 50° C. or greater, such as 50° C. to 150° C., or 60° C. or greater, or 60° C. to 130° C.

Aspect 4: The method according to any one of aspects 1 to 3, wherein the membrane is a ceramic membrane.

Aspect 5: The method according to any one of aspects 1 to 4, wherein the membrane has a pore size of less than 1.5 micron, or 1.5 micron or smaller, or 1.0 micron or smaller, or 0.5 micron or smaller, or 0.2 micron or smaller, or 0.10 micron or smaller, or 0.05 micron or smaller,

Aspect 6: The method according to any one of aspects 1 to 5, wherein the membrane has a hydrophilic surface.

Aspect 7: The method according to any one of aspects 1 to 6, wherein the centrifugal force is between 500 G and 14.200 G, such as at least 500G, or at least 3,500 G, or at least 5,000 G, or at least 10,000.

Aspect 8: The method according to any one of aspects 1 to 7, wherein the circulated rolling oil is heated to a temperature of 50° C. or greater prior to gravity separation or the step of supplying the circulated rolling oil to the separation chamber of the rotating centrifugal rotor, such as 50° C. to 150° C., or 60° C. or greater, or 60° C. to 130° C.

Aspect 9: The method according to any one of aspects 2 to 8, wherein at least 90% (v/v), such as at least 95% (v/v), or 98% (v/v), or 99% (v/v), or 100% (v/v) of the oil-water emulsion and the residual debris do not permeate the membrane.

Aspect 10: The method according to any one of aspects 2 to 9, comprising supplying the reject to a further separation means selected from a centrifuge, a gravity separator, an evaporator, and/or chemical treatment.

Aspect 11: The method according to any one of aspects 2 to 10, comprising heating the reject to a temperature of 50° C. or greater, such as 60° C. or greater, or 70° C. or greater, or 80° C. or greater, or 90° C. or greater (e.g., 50° C. to 150° C., or 60° C. to 130° C.); separating components of the reject by gravity separation; recovering a second supernatant comprising oil and oil-water emulsion; and supplying the second supernatant to the membrane, wherein the oil is recovered from the membrane and an additional reject comprising the oil-water emulsion does not permeate the membrane.

Aspect 12: The method according to any one of aspects 2 to 10, comprising heating the reject to a temperature of 50° C. or greater , such as 60° C. or greater, or 70° C. or greater, or 80° C. or greater, or 90° C. or greater (e.g.,50° C. to 150° C., or 60° C. to 130° C.); supplying the reject to a separation chamber of a second rotating centrifugal rotor; separating components of the reject in the separation chamber of the second rotating centrifugal rotor by centrifugal force; recovering a second supernatant comprising oil and oil-water emulsion; and supplying the second supernatant to the membrane, wherein the oil is recovered from the membrane and an additional reject comprising the oil-water emulsion does not permeate the membrane.

Aspect 13: The method according to aspect 12, wherein the centrifugal force supplied to the second rotating centrifugal rotor is between 500 G and 14,200 G, such as at least 500G, or at least 3,500 G, or at least 5,000 G, or at least 10,000 G.

Aspect 14: The method according to aspect 12, comprising, as a recirculation, supplying the additional reject from the membrane to the second rotating centrifugal rotor; recovering an additional supernatant comprising oil and oil-water emulsion; and supplying the additional supernatant to the membrane, wherein the oil is recovered from the membrane and a reject comprising the oil-water emulsion does not permeate the membrane.

Aspect 15: The method according to any one of aspects 1 to 14, wherein the cleaned rolling oil is substantially free, or totally free, of contaminants comprising water, debris, and oil-water emulsion.

Aspect 16: A method for cleanup of rolling oil, the rolling oil composed of components comprising solid debris, free water, oil, and an oil-water emulsion, the method comprising: i) supplying the rolling oil to a separation chamber of a rotating centrifugal rotor; ii) separating the components of the rolling oil in the separation chamber of the rotating centrifugal rotor by a centrifugal force; iii) recovering a supernatant from the separating step, wherein the supernatant comprises the oil, a substantial portion of the oil-water emulsion, and a residual debris; iv) supplying the supernatant to an inorganic membrane, wherein the oil is recovered from the membrane and a reject comprising the oil-water emulsion and residual debris does not permeate the membrane; v) heating the reject to a temperature of 50° C. or greater; vi) supplying the reject to the separation chamber of the rotating centrifugal rotor; and vii) repeating steps ii) through vi).

Aspect 17: The method of aspect 16, wherein the method is carried out in-line with a metal rolling process, and the rolling oil supplied to the separation chamber of the rotating centrifugal rotor comprises from 5% to 25% (v/v), such as 5 wt. % to 15 wt. % (v/v), of a circulating rolling oil of the metal rolling process.

Aspect 18: The method of aspect 17, comprising, after step iv): supplying the oil recovered from the membrane to the circulating rolling oil.

Aspect 19: The method of aspect 18, comprising, before supplying the oil recovered from the membrane to the circulating rolling oil, supplementing the oil recovered from the membrane with additives.

Aspect 20: The method according to any one of aspects 16 to 19, wherein the rolling oil is heated to a temperature of 50° C. or greater prior to the step of i) supplying the rolling oil to the separation chamber of the rotating centrifugal rotor, iv) supplying the supernatant to an inorganic membrane, or both steps i) and iv).

Aspect 21: The method according to any one of aspects 16 to 20, wherein the membrane is a ceramic membrane.

Aspect 22: The method according to any one of aspects 16 to 21, wherein the membrane has a pore size of less than 1.5 micron, or 1.5 micron or smaller, or 1.0 micron or smaller, or 0.5 micron or smaller, or 0.2 micron or smaller, or 0.10 micron or smaller, or 0.05 micron or smaller.

Aspect 23: The method according to any one of aspects 16 to 22, wherein the membrane has a hydrophilic surface.

Aspect 24: The method according to any one of aspects 16 to 23, wherein the centrifugal force is between 500 G and 14,200 G, such as at least 500 G, or at least 3,500 G, or at least 5,000 G, or at least 10,000.

Aspect 25: The method according to any one of aspects 16 to 24, wherein at least 90% (v/v), such as at least 95% (v/v). or 98% (v/v), or 99 (v/v), or 100% (v/v,) of the oil-water emulsion and the residual debris do not permeate the membrane.

What is claimed is:

1. A method for cleanup of rolling oil, the rolling oil composed of components comprising solid debris, free water, oil, and an oil-water emulsion, the method comprising:
separating the components of the rolling oil by density;
recovering a first supernatant from the separating step, wherein the first supernatant comprises the oil, a portion of the oil-water emulsion, and a residual debris; and
supplying the first supernatant to an inorganic membrane having a pore size of less than 1.5 micron, wherein the oil is recovered from the membrane and a reject comprising the portion of oil water emulsion and residual debris that does not permeate the membrane.

2. The method of claim 1, wherein the step of separating the components of the rolling oil by density comprises:
supplying the rolling oil to a separation chamber of a rotating centrifugal rotor; and
separating the components of the rolling oil in the separation chamber of the rotating centrifugal rotor by centrifugal force.

3. The method of claim 2, wherein the rolling oil is heated to a temperature of 50° C. or greater prior to the step of supplying the roiling oil to the separation chamber of the rotating centrifugal rotor.

4. The method of claim 1, wherein the membrane is heated to a temperature of 50° C. to 150° C.

5. The method of claim 1, wherein the membrane is a ceramic membrane having a pore size of 0.2 micron or smaller.

6. The method of claim 1, wherein the membrane is a ceramic membrane having a pore size of 0.05 micron or smaller.

7. The method of claim 2, wherein the centrifugal force is between 500 G and 5,000 and the membrane is a ceramic membrane having a pore size of 0.2 micron or smaller.

8. The method of claim 2, wherein the centrifugal force is between 3,500 G and 14,200 G, and the membrane is a ceramic membrane having a pore size of 0.05 micron or smaller.

9. The method of claim 1, wherein at least 98% (v/v) of the oil-water emulsion and the residual debris do not permeate the membrane.

10. The method of claim 8, wherein the water content in the oil recovered from the membrane is less than 0.5% (v/v).

11. The method of claim 1, comprising:
supplying the reject to a further separation means selected from a centrifuge, a gravity separator, an evaporator, and/or chemical treatment.

12. The method of claim 1, comprising:
heating the reject to a temperature of 50° C. or greater;
separating components of the reject by density;
recovering a second supernatant comprising oil and oil-water emulsion; and
supplying the second supernatant to the membrane, wherein the oil is recovered from the membrane and an additional reject comprising the oil-water emulsion does not permeate the membrane.

13. The method of claim 2, comprising:
heating the reject to a temperature of 50° C. or greater;
supplying the reject to the separation chamber of the rotating centrifugal rotor;
separating components of the reject in the separation Chamber of the rotating centrifugal rotor by centrifugal force;
recovering a second supernatant from the separating step, wherein the second supernatant comprises oil and oil-water emulsion; and
supplying the second supernatant to the membrane, wherein the oil is recovered from the membrane and an additional reject comprising the oil-water emulsion does not permeate the membrane.

14. The method of claim 13, wherein the membrane is a ceramic membrane having a pore size of 0.2 micron or smaller and the centrifugal force supplied to the rotating centrifugal rotor is between 500 G and 14,200 G.

15. The method of claim 12, comprising, as a recirculation:
supplying the additional reject from the membrane to the separation chamber of the rotating centrifugal rotor;
recovering an additional supernatant comprising oil and oil-water emulsion; and
supplying the additional supernatant to the membrane, wherein the oil is recovered from the membrane and a reject comprising the oil-water emulsion does not permeate the membrane.

16. A method for cleanup of rolling oil, the rolling oil composed of components comprising solid debris, free water, oil, and an oil-water emulsion, the method comprising:
i) supplying the rolling oil to a separation chamber of a rotating centrifugal rotor;
ii) separating the components of the rolling oil in the separation chamber of the rotating centrifugal rotor by a centrifugal force of between 500 G and 14,200 G;
iii) recovering a supernatant from the separating step, wherein the supernatant comprises the oil, a substantial portion of the oil-water emulsion, and a residual debris;
iv) supplying the supernatant to an inorganic membrane having a pore size of 1.5 micron or smaller, wherein the oil is recovered from the membrane and a reject comprising the oil-water emulsion and residual debris does not permeate the membrane;
v) heating the reject to a temperature of 50° C. or greater;
vi) supplying the reject to the separation chamber of the rotating centrifugal rotor;
vii) repeating steps ii) through vi).

17. The method of claim 16, wherein the method is carried out in-line with a metal rolling process, and the rolling oil supplied to the separation chamber of the rotating centrifugal rotor comprises from 5% to 15% (v/v) of a circulating rolling oil in the metal rolling process, the method further comprising, after step iv):
iva) supplying, the oil recovered from the membrane to the circulating rolling oil.

18. The method of claim 17, before step iva), supplementing the oil recovered from the membrane with additives.

19. The method of claim 16, wherein the rolling oil is heated to a temperature of 50° C. or greater prior to the step of i) supplying the rolling oil to the separation chamber of the rotating centrifugal rotor, iv) supplying the supernatant to an inorganic membrane, or both steps i) and iv).

20. The method of claim 16, wherein the membrane is a ceramic membrane having a pore size of 0.2 micron or smaller.
